(19) United States
(12) Patent Application Publication
(10) Pub. No.: US 2016/0110367 A1
(43) Pub. Date: Apr. 21, 2016

(54) SERVICES MANAGEMENT SYSTEM

(71) Applicant: Advanced Technology Consulting Service, Inc., Park Ridge, NJ (US)

(72) Inventor: Manish Krishnan, Park Ridge, NJ (US)

(73) Assignee: Advanced Technology Consulting Service, Inc., Park Ridge, NJ (US)

(21) Appl. No.: 14/515,685

(22) Filed: Oct. 16, 2014

(51) Int. Cl. G06F 17/30; G06F 3/0484; G06F 3/0482; G06Q 40/00

(52) U.S. Cl. CPC G06F 17/3056; G06Q 40/12; G06F 17/30864; G06F 3/04842; G06F 3/0482; G06F 17/30339; G06F 17/30601

(57) ABSTRACT

A services management system includes a services data retrieval module configured to communicate electronically with one or more data storage devices to obtain services data originating from one or more service management organizations or service providers based on services provided by the service providers to recipients of the services. The system includes a plurality of summary tables, each of the summary tables having a predetermined size less than a threshold size corresponding to a predetermined threshold time required to search data in a respective summary table among the plurality of summary tables. The system includes a user interface and a services data graphical user interface (GUI) generator to generate display data to display on the user interface graphics configured to be selected by a user to display analysis data corresponding to a summary table associated with the graphics selected by the user.

### BACKGROUND

The present invention relates to the management of services provided to recipients, and in particular to systems and methods of analyzing data in managed services environments.

Managed services system, such as managed care systems utilized in the healthcare industry, provide payments to service providers or intermediaries, such as insurers, based on metrics associated with subscribers to the managed care system. For example, in a managed healthcare system, an insurer may be reimbursed by the government for the number of members in particular insurance plans. Alternatively, a hospital may be reimbursed based on a type of service provided. In such systems, an oversight entity, such as a government, may mandate particular values to be associated with metrics, such as a value per member, a value per service provided, or any other value. The government may then provide payments to the insurance provider or service provider. Since the actual cost per member or the actual cost per service may vary, the mandated cost may not reflect the actual cost.

Service management organizations, or service providers, (including insurers) typically maintain service data, but the accumulated service data stored in relational databases is very large, often in the millions or hundreds of millions of lines of data. If an oversight entity or other user wishes to analyze the service data to determine the reasonableness of estimated costs, of capitation rates, or any other regulated value, or to determine outliers among services, demographics, or service providers, the relevant data is not readily accessible, due to the time required to physically query the data, analyze the results, provide further queries, and provide programs or other interface layers to interpret or view the searched data.

### SUMMARY

According to at least one non-limiting embodiment, a services management system includes a services data retrieval module. The services data retrieval module is configured to communicate electronically with one or more data storage devices to obtain services data originating from one or more service management organizations or service providers or service management organizations based on services provided by the service providers to recipients of the services. The services management system further includes a plurality of summary tables. Each one of the summary tables contains a quantity of data corresponding to a size in memory less than a size necessary to store the services data in the one or more data storage devices. Each of the summary tables gas a predetermined size less than a threshold size. The threshold size corresponds to a predetermined threshold time required to search data in a respective summary table among the plurality of summary tables. The services management system further includes a user interface and a services data graphical user interface (GUI) generator. The GUI generator includes an electronic graphics controller for generating signals to generate an electronic graphics display, and is configured to generate display data to display on the user interface graphics configured to be selected by a user to display analysis data corresponding to a summary table associated with the graphics selected by the user.

According to another non-limiting embodiment, a services management system comprises a services data retrieval module, a services summary table populator, and a services data graphical user interface (GUI) generator. The services data retrieval module is configured to communicate electronically with one or more data storage devices to obtain services data originating from one or more service management organizations or service providers based on services provided by the service providers to recipients of the services. The services summary table populator is configured to divide the services data into a plurality of separate summary tables corresponding to categories defining bounds of the summary tables. The services summary table populator is further configured to generate the separate summary tables to each have a size less than a pre-determined size corresponding to a predetermined search time for searching each summary table. The services data graphical user interface (GUI) generator is configured to generate display data to display on a user interface graphics configured to be selected by a user to display analysis data corresponding to a summary table associated with the graphics selected by the user.

According to yet another embodiment, a method of managing services comprises retrieving, from one or more storage devices, services data originating from one or more service management organizations or service providers or service management organizations based on services provided by the service providers to recipients of the services. The retrieving is performed by electronically transmission of the services data from the one or more storage devices. The method further includes updating a plurality of summary tables based on the services data. Each one of the summary tables contains a quantity of the services data corresponding to a size in memory less than a size necessary to store the services data in the one or more data storage devices. Each of the summary tables has a predetermined size less than a threshold size. The threshold size corresponds to a predetermined threshold time required to search data in a respective summary table among the plurality of summary tables. The method further includes generating a graphical user interface (GUI) including graphics selectable by a user to display analysis data corresponding to a summary table associated with the graphics selected by the user. The method further includes receiving a user input from the user selecting the graphics, and displaying the analysis data corresponding to the summary table associated with the graphics selected by the user.

According to still another embodiment, a services management method comprises retrieving, from one or more storage devices, services data originating from one or more service management organizations or service providers or service management organizations based on services provided by the service providers to recipients of the services. The retrieving is performed by electronically transmitting the services data from the one or more storage devices. The method further includes generating a plurality of summary tables by dividing the services data based on categories defining bounds of the summary tables. Each of the summary tables has a size less than a pre-determined size corresponding to a predetermined search time for searching each summary table. The method further includes displaying graphics on an electronic display device. The graphics include icons representing one or more of the categories. The method further includes displaying, on the electronic display device, analysis data corresponding to a summary table associated with a category selected by the user by interacting with the graphics on the display device.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 illustrates a block diagram of a fixed (or planned or estimated) cost service system according to an embodiment of the invention;

FIG. 2 illustrates a fixed (or planned or estimated) cost services management system according to an embodiment of the invention;

FIG. 3 is a flow diagram of a method of managing fixed (or planned or estimated) cost services according to an embodiment of the invention;

FIG. 4 illustrates a main database and summary tables according to embodiments of the invention;

FIG. 5 illustrates a graphical user interface (GUI) including a services analysis and overall performance analysis according to embodiments of the invention;

FIG. 6 illustrates a GUI including a healthcare data analysis according to embodiments of the invention;

FIG. 7 illustrates a GUI including a healthcare services data analysis according to embodiments of the invention;

FIG. 8 illustrates a GUI including a healthcare member category and services comparison analysis according to embodiments of the invention;

FIG. 9 illustrates a GUI including an overall performance analysis according to embodiments of the invention;

FIG. 10 illustrates a GUI including an interactive graph according to embodiments of the invention;

FIG. 11A illustrates a distribution chart according to one embodiment;

FIG. 11B illustrates a distribution chart according to another embodiment; and

FIG. 12 is a flow diagram of a method of interacting with a graph according to an embodiment of the invention.

### DETAILED DESCRIPTION

The time required to search service data in large relational databases makes such searches inconvenient or impractical, and finding relevant data is difficult. Embodiments relate to searching and analyzing service data using summary tables generated from larger data sources to facilitate timely searches and to quickly isolate outlier metrics.

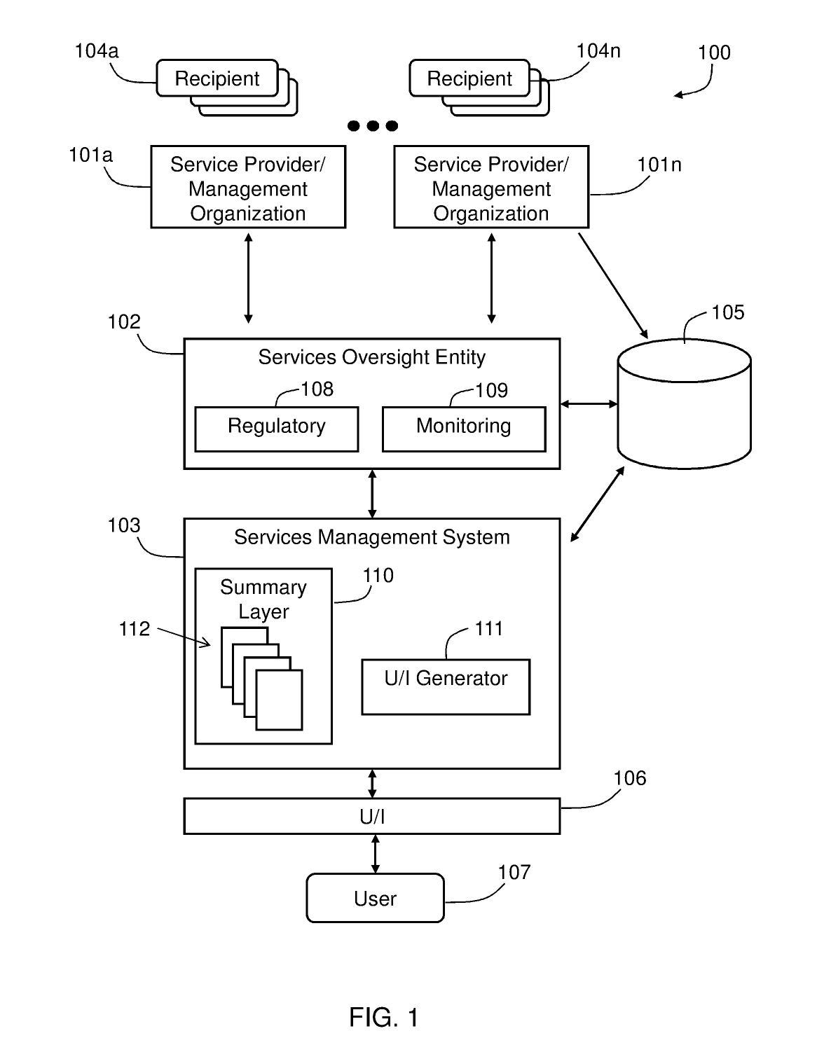

FIG. 1 illustrates a block diagram of a fixed (or planned or estimated) cost service system 100 according to an embodiment of the invention. The system 100 includes service management organizations and service providers 101a to 101n, a services oversight entity 102, and a services management system 103. Service management organizations include insurance companies, risk-management or risk-distributing organizations, and other organizations that have members enrolled in various plans, receive payment from the oversight entity based on the members enrolled or services provided, and provide payment to the service providers. Service providers include any person or organization that provides a service to a recipient. The services oversight entity 102 is any organization that oversees the distribution of a service to recipients 104a to 104n. Examples of oversight entities 102 include government agencies and private companies. The oversight entity 102 may include regulatory 108 functions and monitoring functions 109. For example, in an embodiment in which the oversight entity 102 is a government, the regulatory functions 108 may include lawmakers or administrators formulating regulations to control the distribution of services to recipients 104a to 104n. In a managed-service environment, such as a managed-care environment to provide healthcare to recipients 104a to 104n, the regulatory 108 body of the oversight entity 102 may fix costs associated with providing services to recipients 104a to 104n. In the managed-care environment, the service management organization may include insurance companies and health management organizations, and service providers may include doctors, labs, and hospitals. However, embodiments of the invention are not limited to a healthcare environment, but include any environment in which costs for services provided are managed by an oversight entity.

The monitoring function 109 may include human and computerized systems that track how the services are provided to the recipients 104a to 104n. For example, lawmakers or other administrators may track whether service management organizations and service providers 101a to 101n are expending costs for services within the fixed (or planned or estimated) costs set by the regulatory body 108.

The service management organizations and service providers 101a to 101n provide services to recipients 104a to 104n subject to constraints of the regulatory body 108. For example, in a managed-care environment, the regulatory body 108 may mandate predetermined costs for services, predetermined demographics of recipients 104a to 104n receiving the services, predetermined numbers of recipients 104a to 104n receiving the services, or any other constraints.

The service management organizations and service providers 101a to 101n provide service data regarding services provided to recipients 104a to 104n to a database 105 or other data repository. The service data is based on actual services provided to the recipients 104a to 104n. The monitoring body 109 of the oversight entity 102 typically reviews the service data from the database 105 to monitor the operation of the service management organizations and service providers 101a to 101n. However, a typical database 105 is too large to allow for convenient analysis. For example, a typical database 105 may include millions of lines of data, requiring a typical computer system spend hours or more to complete a search of the database 105 in response to a search query.

In embodiments of the invention, the services management system 103 provides a mechanism for the services oversight entity 102 or any other user 107 to access services data by generating summary tables 112 containing the data from the main database 105, but divided into categories that limit the scope and size of the summary tables 112. In one embodiment, each summary table corresponds to a separate category, and in other embodiments, one summary table includes data from more than one category. The services management system 103 includes a user interface (U/I) generator 111 that generates a user interface 106. The user 107 interacts with the user interface 106 to access the service data categorized in the summary tables 112 of the summary layer 110, allowing the user to quickly access data using a system of guided analytics, in which the user is guided through a series of category selections to display corresponding analysis data. In embodiments of the invention, the services management system 103 is a computer system particularly designed to perform the particular functions of storing, analyzing, and displaying an analysis of service data. The computer system may include any number of networked computers, processors, memory, supporting logic, display devices, or any other devices for storing, analyzing, transmitting, and displaying the service data.

The database 105 represents data organized in physical memory. In one embodiment, the database 105 or data repository is maintained by the service management organizations or service providers 101a to 101n. In such an embodiment, each service provider 101a to 101n may maintain a separate database that makes up a part of the database 105, or all of the service management organizations and service providers 101a to 101n may together maintain a consolidated database 105. In another embodiment, the oversight entity 102 maintains the database 102. In yet another embodiment, the services management system 103 maintains the database 105. For example, in one embodiment, the service providers send services information to service management organizations, which may maintain a database 105, or may transmit the information to an oversight entity 102 (such as a government agency) which may maintain the database 105.

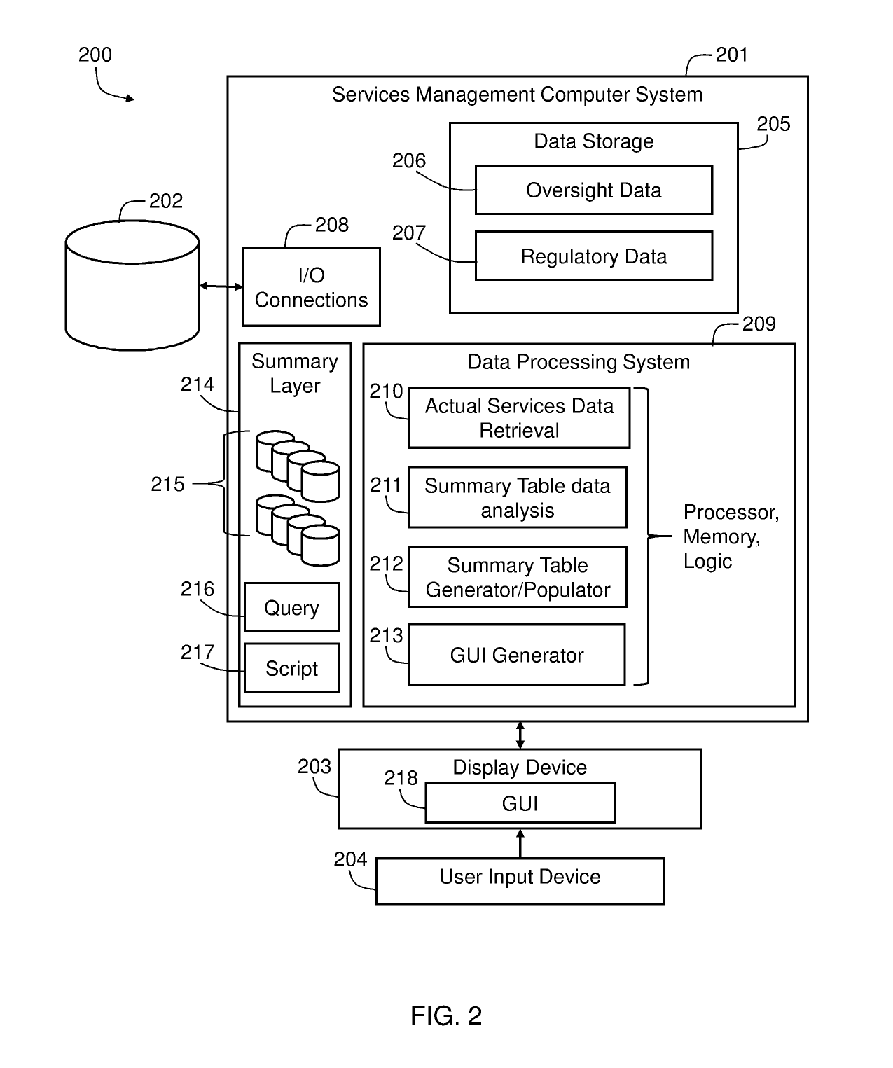

FIG. 2 illustrates a fixed (or planned or estimated) cost services management system 200 according to an embodiment of the invention. The system 200 includes a services management computer system 201, a main database 202, a display device 203, and a user input device 204. The services management computer system 201 may correspond to a component of the services management system 103 of FIG. 1. The main database 202 corresponds to the database 105 of FIG. 1. The display device 203 and user input device 204 correspond to the user interface 106 of FIG. 1.

The services management computer system 201 includes data storage 205, a service data processing system 209, input/output (I/O) connections 208 for communicating electronically with external devices, and a summary layer 214. While all of the data storage 205, service data processing system 209, and summary layer 214 include physical memory, they are illustrated as separate elements in FIG. 2 to illustrate the different purposes for which the physical memory is used, and different types of data structures, addressing, data coding, and data organization that may be used for the different purposes.

The data storage 205 stores oversight data 206 and regulatory data 207. Oversight data 206 may include any type of data provided by an oversight entity to search or analyze service data. For example, oversight data may include category types to-be-searched, threshold values that the oversight entity uses to define outliers, types of data that the oversight entity wishes to have monitored, or any other such data. Regulatory data 207 includes data associated with limitations or conditions placed by a regulatory body on service management organizations and service providers, as well as estimates by the regulatory body regarding services to be provided. Examples of regulatory data 207 include a required or estimated number of service recipients in a given time period, maximum allowed costs or estimated costs to perform services, or capitation rates, types of services to be provided by service management organizations and service providers, maximum or estimated total costs of services provided, or any other data either mandated or estimated by a regulatory body to manage the distribution of services by service management organizations and service providers.

The service data processing system 209 is made up of any number of processors, processor cores, memory chips, integrated circuits, and logic that store instructions and data and execute instructions to retrieve, analyze, and generate data. The service data processing system 209 includes an actual services data retrieval module 210 that retrieves data from the database 202 corresponding to actual services provided by service providers to recipients, corresponding to members enrolled with a service management organization, or corresponding to any actual number as opposed to an estimated number of members or services expected to be enrolled or performed. A summary table populator 212 generates a plurality of summary tables 215 in the summary layer 214 based on predetermined size and content criteria. In particular, the size of each summary table 215 is limited to be less than a threshold size corresponding to a threshold time required to perform an electronic search of the data in the summary table 215. Each summary table 215 is also associated with one or more categories. Accordingly, a summary table 215 may be selected for searching or analysis based on the category associated with the summary table 215, and the time it takes to search or analyze the data in the summary table 215 will not exceed the predetermined time threshold. The summary table 215 may contain data from only one category or from multiple categories. For example, if multiple categories together would result in a summary table 215 of a size such that searching the summary table 215 and returning a search result would fall within the threshold time, then the summary table 215 may be formed to include data from multiple categories. Queries 216 and scripts 217 may also be generated by the summary table populator 212 or other sources, such as by programmers, to facilitate data transfer from the summary tables 215 to the summary table data analysis module 211.

By way of example, the database 202 may include millions of blocks or lines of data. Querying the database 202 to attempt to extract particular information may take an inconvenient amount of time, such as hours or even days. However, selecting a summary table 215 having only a sub-set of the data in the database 202 for searching or analysis is designed to take no more than a predetermined period of time, such as seconds. The summary table populator 212 therefore generates summary tables 215 having particular sizes, and therefore identifies categories of corresponding sizes, such that a search or analysis of data in the summary table 215 falls within the predetermined time threshold. In one embodiment, the size of each summary table 215 is at least an order of magnitude less than a size of the database 202. However, in some embodiments, the size of each summary table 215 is two orders of magnitude, three orders of magnitude, four orders of magnitude, or more orders of magnitude less than the size of the database 202.

As an example, if an oversight entity, user, programmer, or other entity desires to be able to search data in the database 202 by category X (such as searching for data spanning a time period of two years), the summary table populator 212 may identify category X as containing too much data to be searched or analyzed within the time threshold. In such a case, the summary table populator 212 may suggest, or a human programmer may identify, one or more other categories that may be implemented either in place of, or as prerequisites to, searching by category X. In the example in which the category X corresponds to data spanning two years, one example of a substitute category may be a time period of one year instead of two years. Alternatively, a prerequisite category may be required. For example, searching by a particular service provider may reduce the size of the summary table 215 to fall within the time threshold. In such a case, each service provider may be a separate category corresponding to a separate summary table. Another summary table may then be generated for each separate service provider including data spanning over two years. A subsequent search of category X may be performed, resulting in data corresponding to the selected service provider over the period of two years.

While examples have been described in which each category corresponds to a separate summary table, embodiments of the invention encompass multiple categories being associated with the same summary table. For example, if the summary table generator/populator 212 determines that each summary table must be less than a certain size to satisfy a search time threshold, and that data associated with two separate categories may be combined in the same summary table and still maintain the summary table within the search time threshold, then a summary table may be generated that corresponds to the two separate categories, and the search table may be populated with the data from the two separate categories. Of course, data from any number of separate categories may be combined in a single summary table, as long as the size of the summary table is maintained small enough to satisfy the search time threshold.

Accordingly, the summary table generator/populator 212 identifies potential summary tables 215 that meet predetermined search time criteria and that correspond to desired search categories. The summary table generator/populator 212 may also identify desired categories that would, alone, correspond to summary tables that would not fall within the predetermined search time thresholds. The summary table generator/populator 212 may recommend, either automatically via a processor analyzing data or in conjunction with human input, one or more alternative categories or one or more prerequisite categories, that would result in summary tables that meet the predetermined search time criteria.

In other words, in embodiments of the present invention, a human may generate the summary tables manually by programming a computer to form the summary tables in the computer, or a computer processing circuit may generate the summary tables based on predetermined criteria provided by a user or system. The computer processing circuit may then populate the previously-generated summary tables over time as data associated with the summary tables' changes.

The service data processing system 209 includes a graphical user interface (GUI) generator 213 configured to generate a GUI 218 on a display device 203 including graphics representing categories associated with the summary tables 215 and analysis data of the service data in the summary tables 215. The GUI 218 includes one or more graphics or icons with which a user can interact via the user input device 204 to select categories for analysis, and to modify types of analysis performed and data content displayed. In embodiments of the invention, the GUI generator 213 includes an electronic graphics processor that receives service data and converts the service data to a graphical format identifiable by a user on the GUI 218. In embodiments of the invention, the display device 203 includes any type of display device providing visual, audio, tactile, or any other form of data to a user to allow the user to recognize data and interact with the GUI to make selections and generate a new display based on the selection. For example, while some embodiments are described with reference to visual displays, it is understood that for various reasons, including visual handicaps or convenience, data that is typically provided as visual data may be provided in alternative formats, including audio or tactile formats.

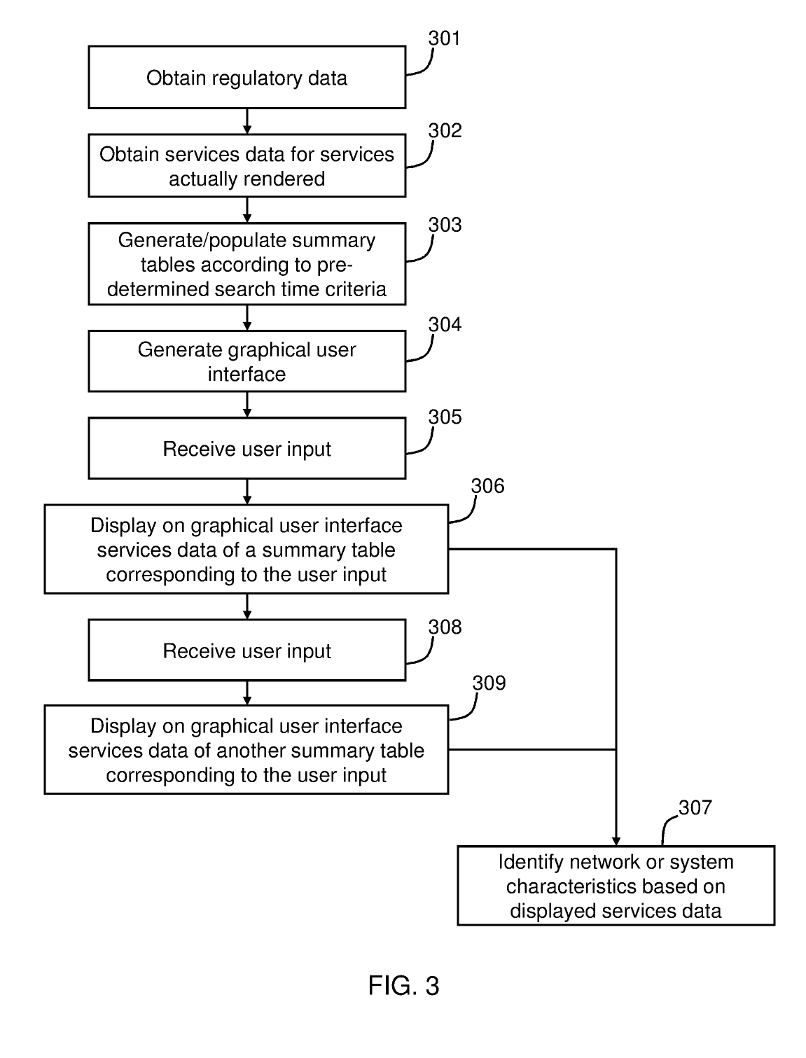

FIG. 3 is a flow diagram of a method of managing fixed (or planned or estimated) cost services according to an embodiment of the invention. In block 301, regulatory data is obtained. The regulatory data includes fixed, mandated, or estimated costs associated with services. The regulatory data may include other fixed, mandated, or estimated data associated with the services. Other examples of regulatory data include a fixed, mandated, or estimated number of service recipients to be provided service by a service provider in a given time period, mandated types of services to be provided by service providers, fixed, mandated, or estimated numbers of times that particular services will be provided by service providers, estimated total costs of services provided, or any other data either fixed, mandated, or estimated by a regulatory body to manage the distribution of services by service providers. In some embodiments, regulatory data is mandated or estimated by a government entity, and in other embodiments, the regulatory data is mandated or estimated by another oversight entity, such as services management organizations, independent oversight or regulatory agencies, or any other management organizations. Referring to FIG. 2, for example, the regulatory data 207 may be accessed by the services management computer system 201 via the I/O connections 208 connected to computers or servers of an oversight entity, and the regulatory data 207 may be stored in the data storage 207 for use by the data processing system 209.

In block 302 services data is obtained for services actually rendered. The services data includes any type of data associated with services rendered, including a cost of the service, a name of a provider, a type of recipient, a time when the service was provided, or any other data. Referring to FIG. 2 by way of example, the actual services data retrieval module 210 of the data processing system 209 may access the services data from the database 202 via the I/O connections 208.

In block 303, summary tables are generated and populated according to predetermined search criteria. In particular, the size of each summary table is limited to be less than a threshold size corresponding to a threshold time required to perform an electronic search of the data in the summary table. Each summary table is also associated with one or more categories. Accordingly, a summary table may be selected for searching or analysis based on the category associated with the summary table, and the time it takes to search or analyze the data in the summary table will not exceed the predetermined time threshold. Referring to FIG. 2, for example, the summary table generator/populator 212 may generate the summary tables 215 based on predetermined search criteria. After the summary tables 215 are initially generated, the summary table generator/populator 212 may populate the summary tables 215 as the data in the database 202 is updated. In one embodiment, the generation of the summary tables is performed manually by a programmer or user, and the population is performed automatically by a computer processor when new data is provided to populate the summary tables. In another embodiment, the computer processor both generates the summary tables based on predetermined criteria and populates the tables over time.

The data in the summary tables is the data located in a main database or data repository which stores all the services data from one or more service management organizations or service providers. However, whereas the main database is a large database containing substantial amounts of data, such as millions of blocks of data or lines of data, the summary tables are divided and generated to contain much smaller amounts of data to permit convenient searches and analysis of the data. In some embodiments, the size of the summary tables is one or more orders of magnitude less than a size of the main database or data repository from which the summary tables are divided or generated.

In block 304, a graphical user interface (GUI) is generated. The GUI includes graphics or icons representing categories, each category associated with a separate summary table. Each summary table may be associated with only one category, or each summary table may be associated with multiple categories, depending on the size of data corresponding to each category. The GUI is generated to be displayed on a display device to be viewed or otherwise detected, sensed, and interacted-with by a user. Referring to FIG. 2, for example, a GUI 218 is displayed on the display device 203 in communication with the GUI generator 213 of the data processing system 209.

In block 305, a user input is received based on the GUI displayed. In particular, a user selects one or more categories based on graphics or icons displayed by the GUI. The GUI may then be modified in block 306 to display data, such as financial data, performance overview data, or any other type of data associated with the selected category. Examples of displayed data include regulatory data associated with the category, actual services rendered data associated with the selected category, costs incurred, services provided, comparisons of different service providers associated with the selected category, rate changes, cost over-runs, or any other data either stored in the summary table associated with the selected category or calculated based on the data stored in the summary table associated with the category.

In block 307, outliers are identified based on the displayed services data. Outliers may be displayed by an electronic data processing system, such as the data processing system 209 of FIG. 2, by comparing data stored in the summary tables with threshold values, or may be identified by users viewing data from the summary tables displayed on a display device. The threshold values may be based on median values, average values, mean values, or any other desired thresholds. In one embodiment, a visual or other sensory indicator is provided to identify an outlier. For example, if a particular service cost is greater than or lower than a threshold cost established by an oversight entity, the particular service cost may be highlighted, bolded, displayed in a different color, or any other identifier may be provided to draw attention to the outlier.

In one embodiment, displaying the service data on a display device with the GUI includes generating a graph or chart representing the mathematical data stored in the summary table associated with the selected category. In such an embodiment, a user may interact with the graph or chart to identify services data, including service providers, costs, or any other data, associated with any point on the chart or graph.

In block 308, another user input is received to select another category associated with another summary table. The selection in block 308 may be based on the previous selection of block 305, such that the selected category combines with the category of the selection of block 305 to further limit the scope of searched data. Accordingly, the summary table associated with the selection of block 308 is smaller than the summary table associated with the selection of block 305, and may return search and analysis results even faster than from the selection of block 305.

Accordingly, categories and summary tables may be selected by users interacting with a graphical user interface to permit the users to narrow the scope of a data analysis to zero in on outliers, inconsistencies, or any other data metric or characteristic. The search and analysis is performed at a much faster rate using the summary tables than with a parent database encompassing all of the data of all of the summary tables, since each summary table is of a size corresponding to a particular search speed, so that only sub-sets of data from the total possible amount of service data is ever analyzed or searched. Thus, users may analyze data and identify outliers and other data characteristics or patterns in a guided fashion by selecting successive categories that further limit the scope of data to be searched, and which in each successive search, result in searches of smaller amounts of data.

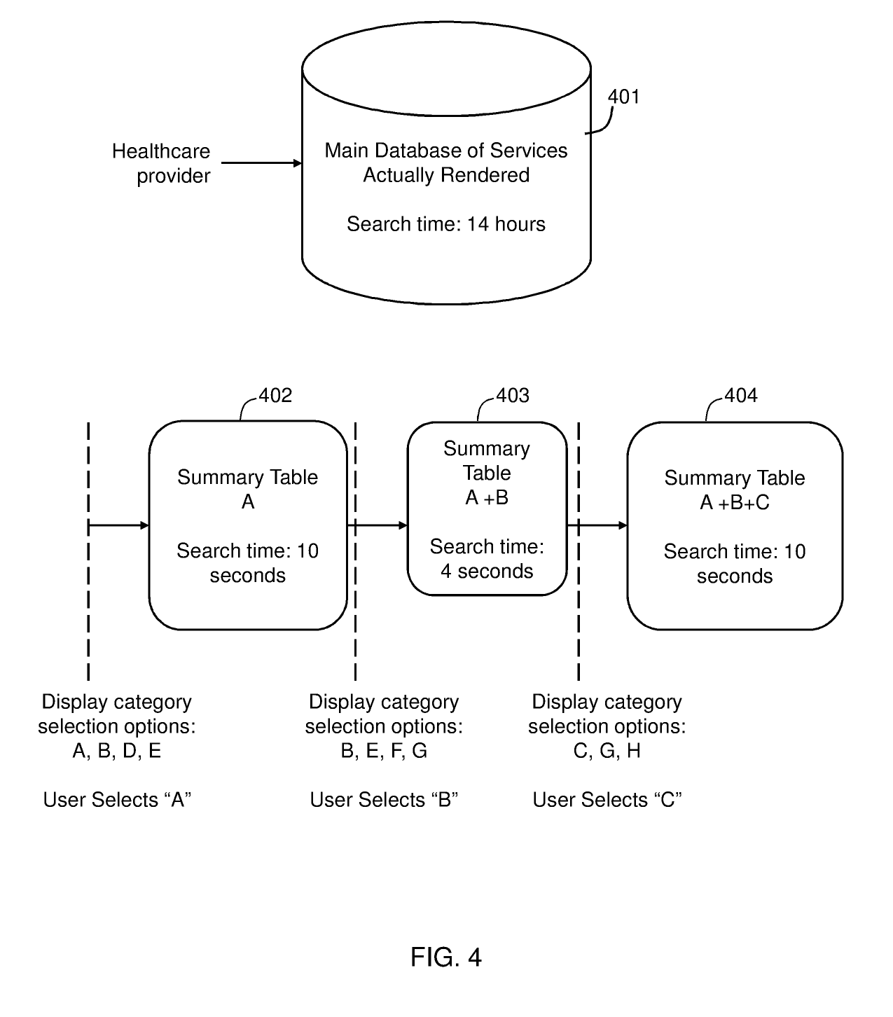

FIG. 4 illustrates a main database 401 and summary tables 402, 403, and 404 according to embodiments of the invention. The main database 401 is a main database of healthcare services actually rendered to patients, and is populated by data from one or more healthcare providers, health insurers, health management organizations, or other health organizations based on the healthcare providers' actual services rendered. While a database of healthcare services rendered is illustrated by way of example, it is understood that embodiments are not limited to the field of healthcare, but encompass any type of database of services provided, and in particular services in which some aspect of the service is managed by an oversight entity. The main database 401 is a large database containing a large quantity of data, and so searching the database 401 in response to a query would take 14 hours. Typically, searching databases containing data regarding actual services rendered from multiple health providers or health organizations over a period of one or more years would take anywhere from a few hours to days.

A number of first-tier summary tables are generated from the data in the main database 401. Summary table A 402 represents one such first-tier summary table. The first-tier summary tables 402 are the largest summary tables and correspond to the first possible selection by a user in a chain of selections of summary tables. In FIG. 4, a first set of categories A, B, D, and E are displayed to a user, corresponding to summary table A 402, as well as additional summary tables B, D, and E respectively. Summary tables B, D, and E are not shown, for purposes of clarity in description. Each category A, B, D, and E corresponds to a separate summary table of a size that falls within a predetermined threshold corresponding to a threshold time required to search the summary table. For example, the threshold time may be 20 seconds. In FIG. 4, summary table A 402 is illustrated as having a search time of 10 seconds. Accordingly, once the user selects category A, data corresponding to the category may be displayed in around 10 seconds, or slightly more, depending on the graphics displayed.

In addition, upon selecting category A corresponding to summary table A 402, a second set of categories B, E, F, and G are displayed. Summary tables A+D, A+E, A+F, and A+G are not shown, for purposes of clarity in description. Each category B, E, F, and G corresponds to a separate summary table of a size that falls within a predetermined threshold corresponding to a threshold time required to search the summary table. In particular, since the second set of categories, B, E, F, and G, are second-tier categories, they correspond to summary tables A+ (B, E, F, and G), respectively. The additional limiting criteria of the second-tier categories further reduce the amount of data that falls within the categories, further reducing a search time of an associated summary table. For example, the summary table A+B includes only the data that falls within both the categories A and B, which is less data than would fall within either category A or category B. By way of example, category A may be a service provider, and category B may be a type of service provided. Selection of only category A would result in all the services provided by the service provider A. Selection of only category B would result in all the service providers that provide service B. However, selection of both categories A and B results in only data corresponding to the service B performed by the provider A.

In FIG. 4, the second set of categories includes categories B and E, which were also in the first set of categories, and categories F and G which were not in the first set of categories. Some second-tier, third-tier, or subsequent-tier categories may not be selected in earlier tiers, or may require pre-requisite selections before they are available to be selected. Other categories, such as categories B and E of FIG. 2, do not require any pre-requisite selections. Accordingly, categories that would require summary tables too large to meet a search time threshold may not be available for selection until other categories are first selected to limit the scope of data being searched.

In FIG. 4, the user selects category B, the summary table A+B 403 is searched, taking 4 seconds, and the corresponding data from the summary table A+B 403 is displayed, together with a third set of categories C, G, and H. If a user selects the category “C”, then the summary table A+B+C is searched in 2 seconds, and the corresponding service data is displayed to a user.

While FIG. 4 illustrates an embodiment in which a separate summary table is generated for each category, embodiments of the invention encompass a combination of utilizing summary tables and search queries to generate display data. For example, in FIG. 4, instead of searching a separate summary table A+B+C 404, the selection of category C by a user may instead result in a query that merely limits the scope of returned data from the database A+B 403 to data that also falls within the category C. In such an embodiment, the search time of the query is still calculated to fall within the threshold search time, since the search of database A+B 403 is well within the threshold search time.

While FIG. 4 illustrates particular times (“10 seconds,” “4 seconds,” and “2 seconds”), these times are provided only by way of example, and different systems have different search and response times. Embodiments of the invention encompass systems having search and response times that are configured, based on size of the generated summary tables and other system characteristics, to have search and response times within particular thresholds. According to an embodiment, the threshold time may be 20 seconds, for example.

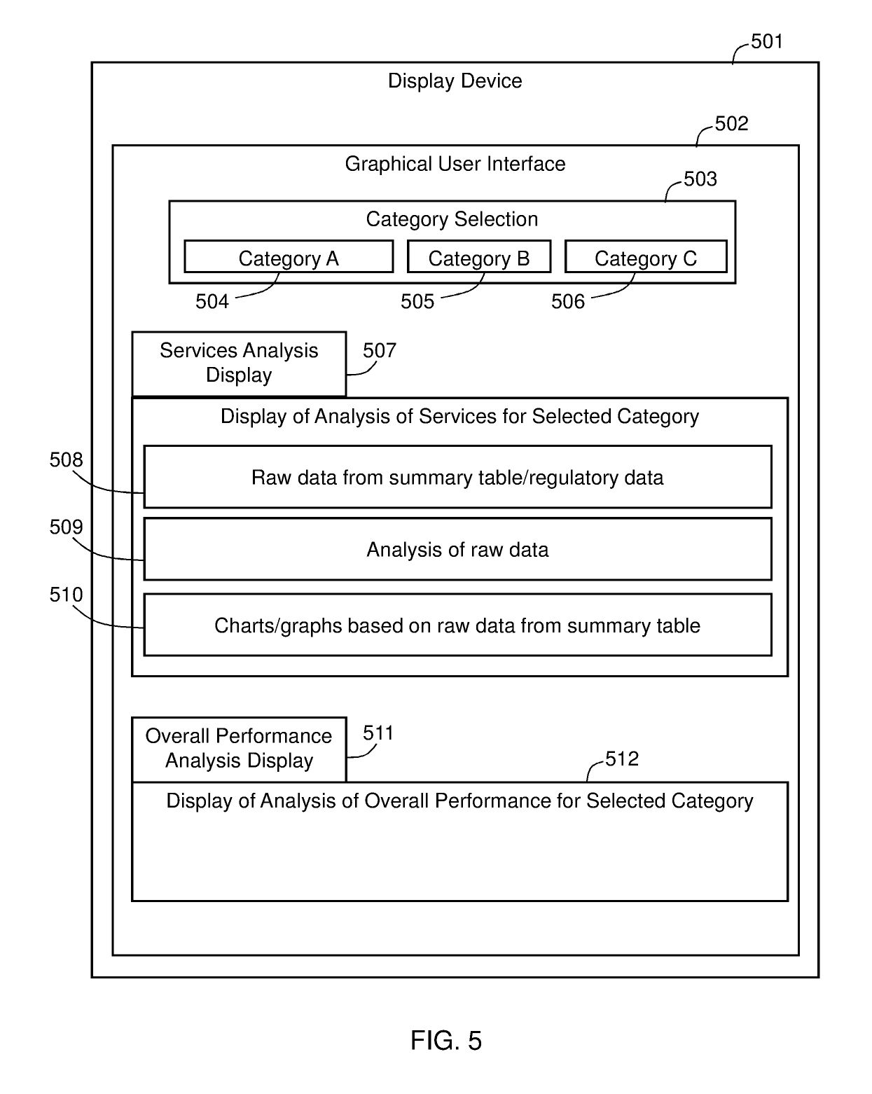

FIG. 5 illustrates a graphical user interface (GUI) 502 including a services analysis and overall performance analysis according to embodiments of the invention. The GUI 502 may be displayed on a display device 501. The GUI 502 includes a category selection region 503 and one or more categories selectable by a user, Category A 504, Category B 505, and Category C 506. While Categories A to C 504 to 506 are illustrated as separate buttons by way of example, embodiments encompass any display of the categories, including as a drop-down menu, pictures, graphics, or any other graphical representation.

In one embodiment, the GUI 502 includes a services analysis display 507 and an overall performance analysis display 511. The data populating the services analysis display 507 and the overall performance analysis display 511 is obtained from the categories selected by the user, and the corresponding summary tables. The services analysis display 507 may include raw data from a summary table and regulatory data. An example of raw data may be a number of services provided by a service provider or managed by a health organization, since such a number does not require analysis. An example of regulatory data may be a mandated or estimated cost to perform a service.

The services analysis display 507 further includes an analysis of the raw data, such as changes over time, differences between reported rates and estimated rates, or any other analysis of the data. The service analysis display 507 may also include charts and graphs 510 based on the raw data from the selected summary table.

The services analysis display displays data based on services and types of recipients or categories of recipients. In contrast, the overall performance analysis display includes comparative data, such as a cost per member, a cost per recipient, a cost per claim, a number of claims per member, and a number of claims per recipient. The services analysis display and the overall performance analysis display may be provided on a same GUI or on separate GUIs or display screens.

In one embodiment, the services analysis display 507 and overall performance analysis display 511 are tabs or other selectable buttons or icons to permit a user to move between an analysis of services and overall performance. In other words, the data in a summary table may be analyzed and viewed in different formats by receiving a user input. In addition, re-searching or re-analyzing data in the summary table to provide a new display of the data is performed quickly—within a threshold search time—since the data is associated with a summary table configured to be searchable within the threshold search time.

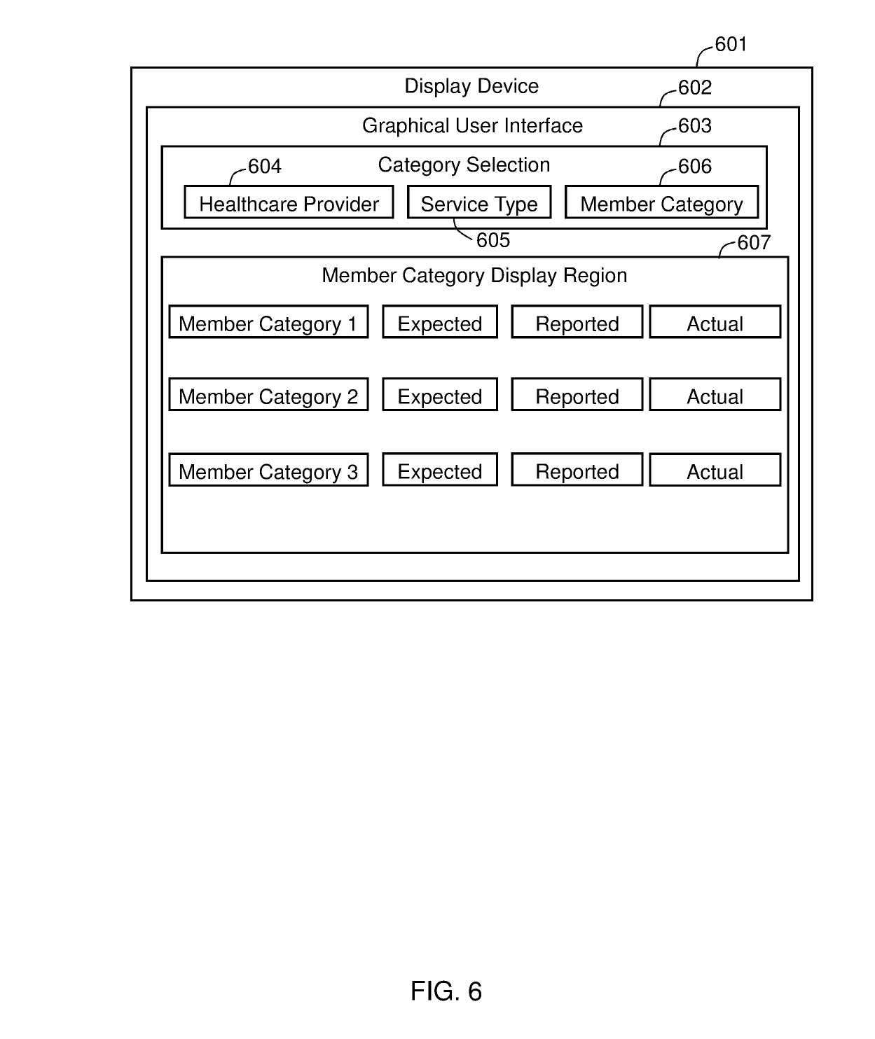

FIG. 6 illustrates an example of a graphical user interface (GUI) 602 displaying services analysis data in the healthcare context, by way of example. The GUI 602 is displayed on a display device and includes a category selection section 603 including one or more categories. In FIG. 6, three examples of categories are provided: Healthcare provider 604, Service Type 605, and Member Category 606. However, these categories are provided by way of example, and embodiments of the invention are not limited to the healthcare context, or to these particular categories. In the present specification and claims, the term “member category” is given its particular meaning in the field of managed healthcare, which is a categorization of members based on estimated risk. Some example categories of aid include Maternity, Medicare, Children, Parents, etc.

The categories 604 to 606 are selectable by a user to search or analyze data in a summary table associated with the categories 604 to 606. The GUI further includes a member category display region 607 including columns for “member category”, “expected cost per member,” “reported cost per member,” and “actual cost per member.” For each member category in the “member category” column, there may be an associated “expected cost per member,” or a rate that an oversight entity (such as a government) agrees to pay a service provider. In the context of healthcare, for example, the government may agree to pay a healthcare management organization X dollars per month for each adolescent enrolled and Y dollars for each pregnant woman enrolled. In other words, the compensation is not based on services provided, but rather based on members classified by type. The “reported cost per member” may correspond to a rate that a healthcare organization represents to the oversight entity as the amount that it costs the service provider per member in the particular member category. Based on the service data provided, the “actual cost per member” may be calculated using claims data stored in one or more summary tables, corresponding to the actual cost to the healthcare organization (as opposed to the reported cost) per member in the particular member category. Accordingly, a user may determine whether the actual cost for a member is reasonable or within a desired or predetermined range of the expected rate. In addition, the user can determine whether a rate provided as the cost to the healthcare organization (i.e. the “reported cost per member”) is accurate.

While FIG. 6 illustrates only three categories 604 to 606 by way of example, embodiments of the invention encompass any number of selectable categories. In addition, when a user selects one of the categories 604 to 606 and service data associated with the category is searched, analyzed, and displayed, additional categories may be displayed to further narrow the scope of data to be searched and analyzed.

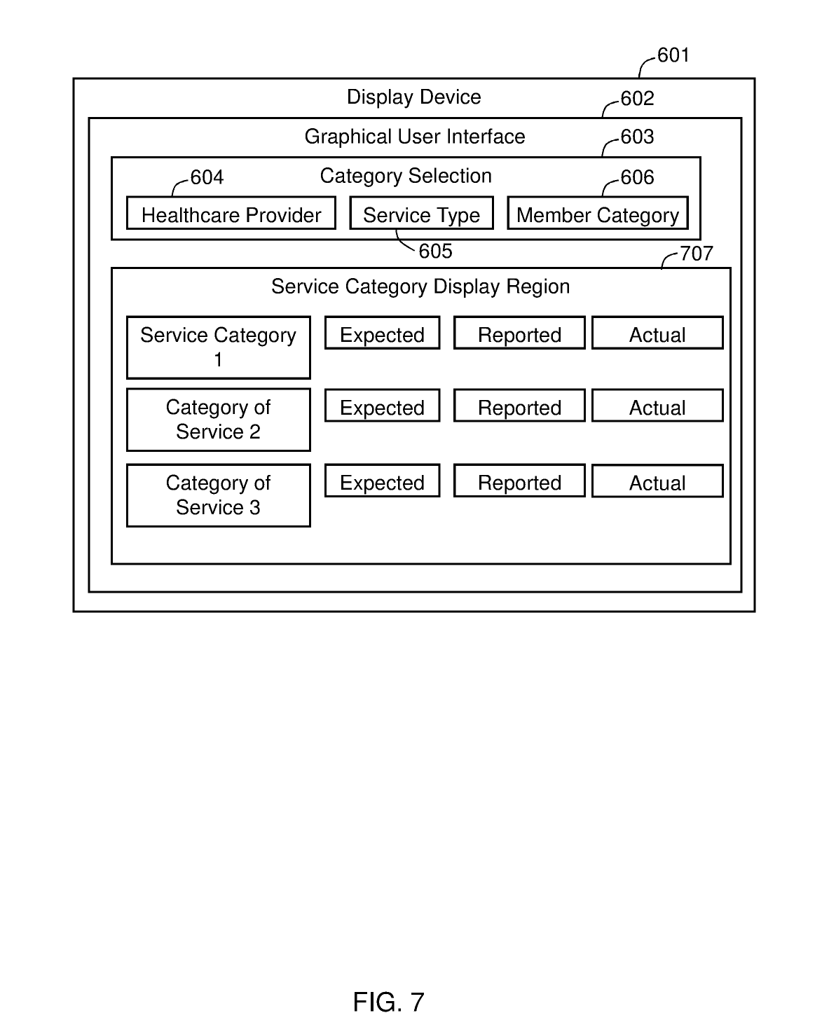

FIG. 7 illustrates another example of a graphical user interface (GUI) 602 displaying services analysis data in the healthcare context. The GUI 602 is displayed on a display device and includes a category selection section 603 including one or more categories. In FIG. 7, three examples of categories are provided: Healthcare provider 604, Service Type 605, and Member Category 606. However, these categories are provided by way of example, and embodiments of the invention are not limited to the healthcare context, or to these particular categories.

The categories 604 to 606 are selectable by a user to search or analyze data in a summary table associated with the categories 604 to 606. The GUI further includes a service category display region 707 including columns for “service category”, “Expected Cost Per Member,” “reported cost per member,” and “actual cost per member.” For each service category in the “service category” column, there may be an associated “Expected Cost Per Member,” or a rate that an oversight entity (such as a government) agrees to pay a service management organization, such as a healthcare provider. Alternatively, the oversight entity or a service management organization may estimate an “Expected Cost Per Member” based on a fixed amount paid to the service management organization per member in an insurance program associated with the service management organization.

In the context of healthcare, for example, the government may agree to pay a healthcare management organization X dollars per month for each adolescent enrolled and Y dollars for each pregnant woman enrolled. In other words, the compensation is not based on services provided, but rather based on members classified by type. The “reported cost per member” may correspond to a rate that a healthcare management organization represents to the oversight entity as the amount that it costs the service provider per member to perform the particular service in the “Service category” column. Based on the service data provided, the “Actual Cost Per Member” may be calculated using claims data stored in one or more summary tables, corresponding to the actual cost to the service provider (as opposed to the reported cost) per member to provide the service. Accordingly, a user may determine whether the actual cost for a member to provide a service is reasonable or within a desired or predetermined range of the expected cost. In addition, the user can determine whether a rate provided as the cost to the service provider (i.e. the “reported cost per member”) is accurate. By viewing the analysis of expected cost per members and actual cost per members in terms of service category, even when payments may be distributed based on a member category of members in a healthcare program, a user may determine whether some services are relatively expensive to perform while others are relatively inexpensive, and may adjust operations accordingly.

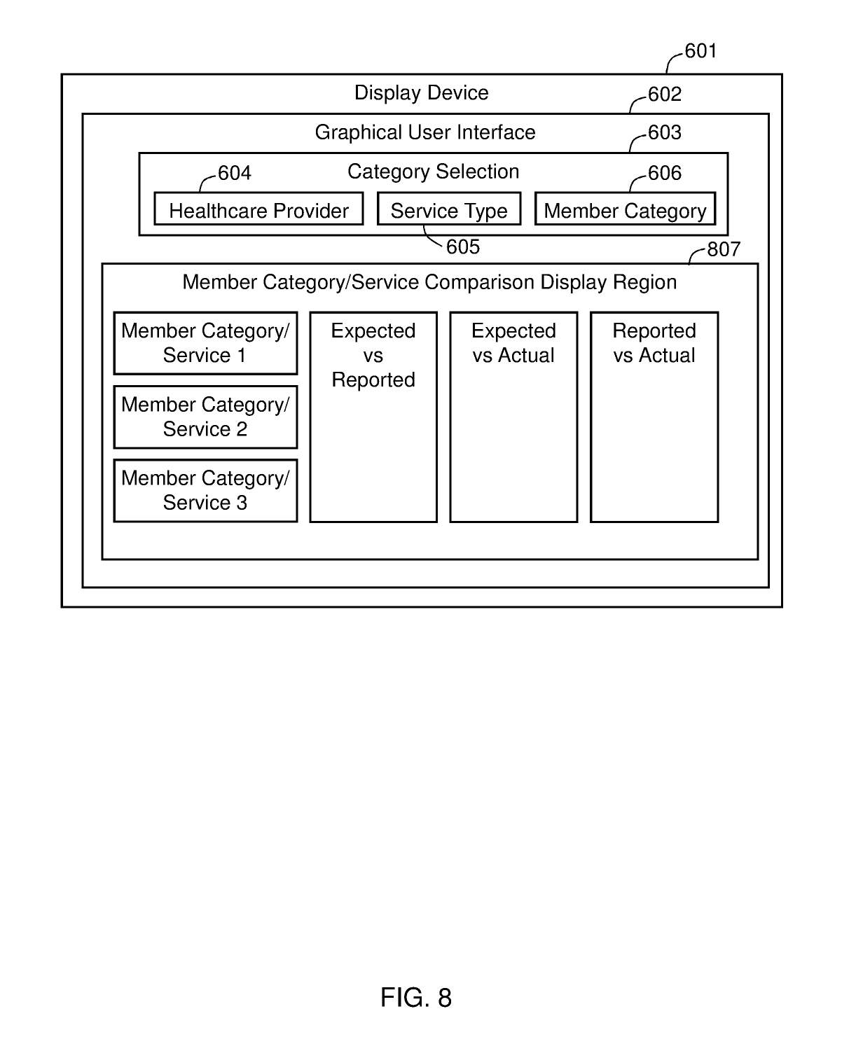

FIG. 8 illustrates yet another example of a graphical user interface (GUI) 602 displaying services analysis data in the healthcare context. The GUI 602 is displayed on a display device and includes a category selection section 603 including one or more categories. In FIG. 7, three examples of categories are provided: Healthcare provider 604, Service Type 605, and Member Category 606. However, these categories are provided by way of example, and embodiments of the invention are not limited to the healthcare context, or to these particular categories.

The categories 604 to 606 are selectable by a user to search or analyze data in a summary table associated with the categories 604 to 606. The GUI further includes a member category/service comparison display region 807 including columns for “member category/service”, “Expected Cost Per Member vs. Reported Cost Per Member,” “Expected Cost Per Member vs. Actual Cost Per Member,” and “Reported Cost Per Member vs. Actual Cost Per Member.” Accordingly, a user is able to quickly identify relationships and discrepancies in a selected category between an expected cost per member and an actual cost per member, and between a reported cost per member and an actual cost per member.

While FIGS. 6-8 are illustrated separately, embodiments of the invention encompass one or more of the GUIs of FIGS. 6-8 being located on a same screen or GUI.

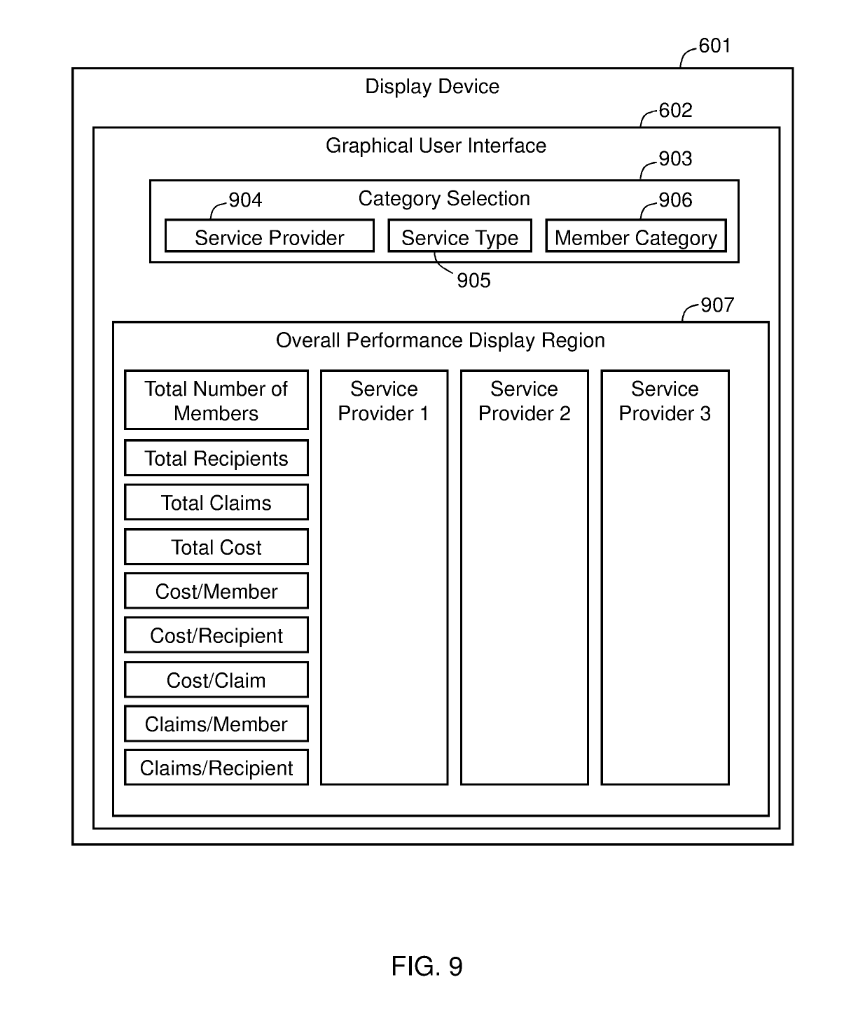

FIG. 9 illustrates a GUI 602 displaying an overall performance analysis according to embodiments of the invention. The GUI 602 is displayed on a display device 601, and includes a category selection region 903 and an overall performance display region 907. In FIG. 9, three categories, “service provider” 904, “service type” 905, and “member category” 906 are provided by way of example, but embodiments encompass any categories selectable by a user to select corresponding summary tables.

The overall performance display region 907 displays overall statistics and figures as opposed to statistics and figures based on particular services or types of recipients. Examples of overall performance metrics include “total number of members,” “total recipients,” “total claims,” “total cost,” “cost per member,” “cost per recipient,” “cost per claim,” “claims per member,” and “claims per recipient.” The overall performance display region 907 displays each of these metrics associated with particular service management organization or service provider, providing an instant overview of performance indicators of each of the service management organizations or service providers.

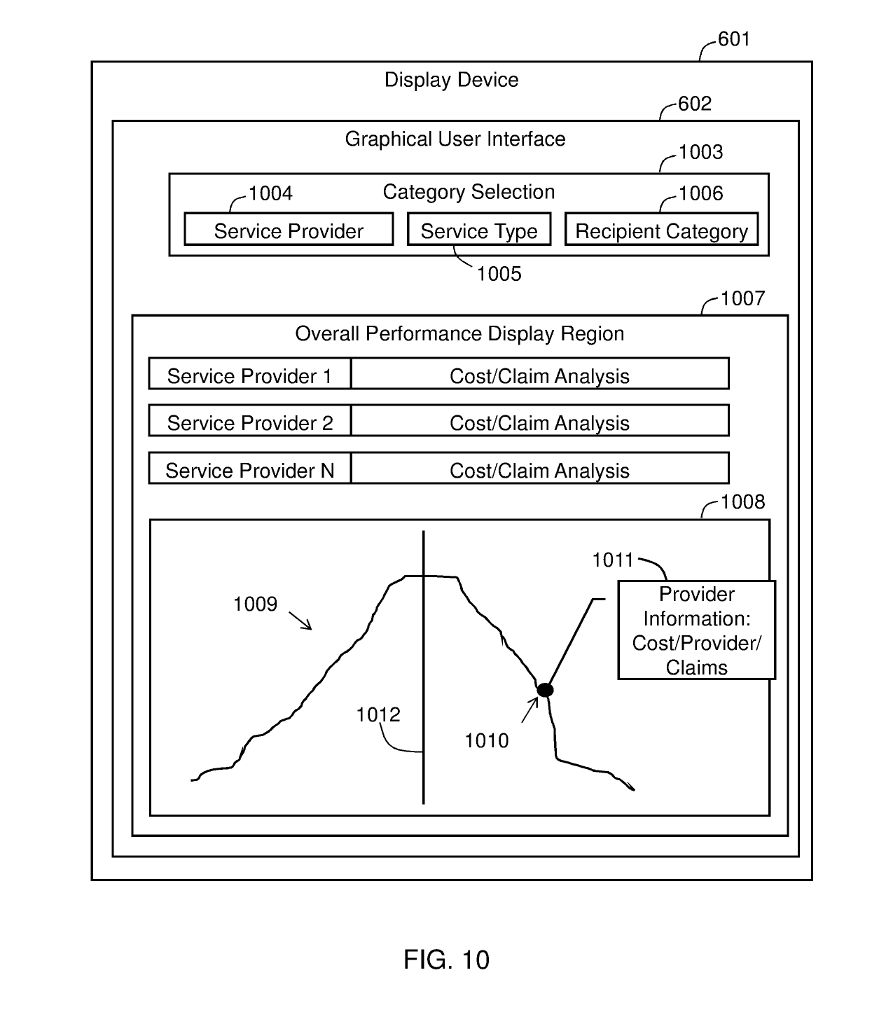

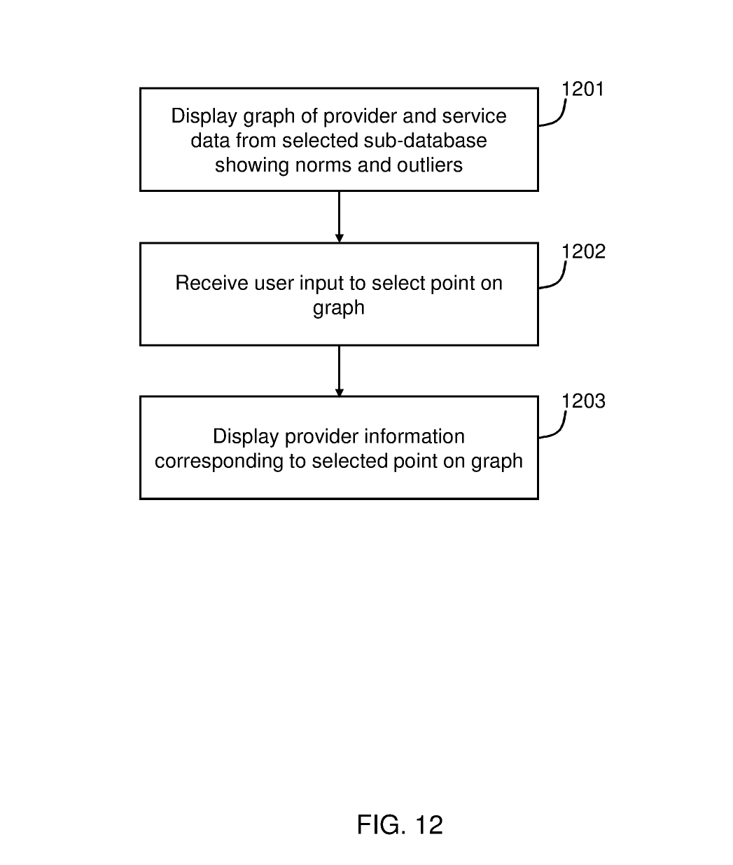

FIG. 10 illustrates a GUI 602 including an interactive graph 1008 according to embodiments of the invention, and FIG. 12 is a flow diagram illustrating a method for interacting with the graph to identify outliers and other services data.

The GUI 602 is displayed on a display device 601 and includes a category selection region 1003. In FIG. 10, three categories, “service provider” 1004, “service type” 1005, and “recipient category” 1006 are provided by way of example, but embodiments encompass any categories selectable by a user to select corresponding summary tables.

The GUI also includes an overall performance display region 1007 including service provider information, cost/claim analysis information, and an interactive graph 1008. The graph 1008 may represent any metrics, such as “cost” along a horizontal axis and “number of times provider at a cost/claim level” along a vertical axis. Referring to FIG. 12, in block 1201, the graph 1008 is displayed including provider and service data from a summary table selected by a user.

Embodiments of the invention include generating a distribution chart, as illustrated in FIG. 10. The categorization of data and generation and population of summary tables makes the generation of the distribution chart very fast compared to systems in which an entire database is queried for data. In embodiments of the invention, the distribution chart provides a visual depiction such that the shape of the chart may be used to determine the health, robustness, or effectiveness of a service provider system or network.

For example, the distribution chart shown in the graph 1008 depicts a relatively healthy system, in which the majority of service management organizations or service providers provide a service around the median 1012 and the outlier providers drop of to the left and right of the median 1012, indicating that some service management organizations or service providers have higher costs and some have lower costs, but the majority have costs around a median 1012. Accordingly, a relatively healthy or effective system or network may be identified by a distribution chart having a “bell” type shape, with an apex of the bell corresponding, approximately, to a median value.

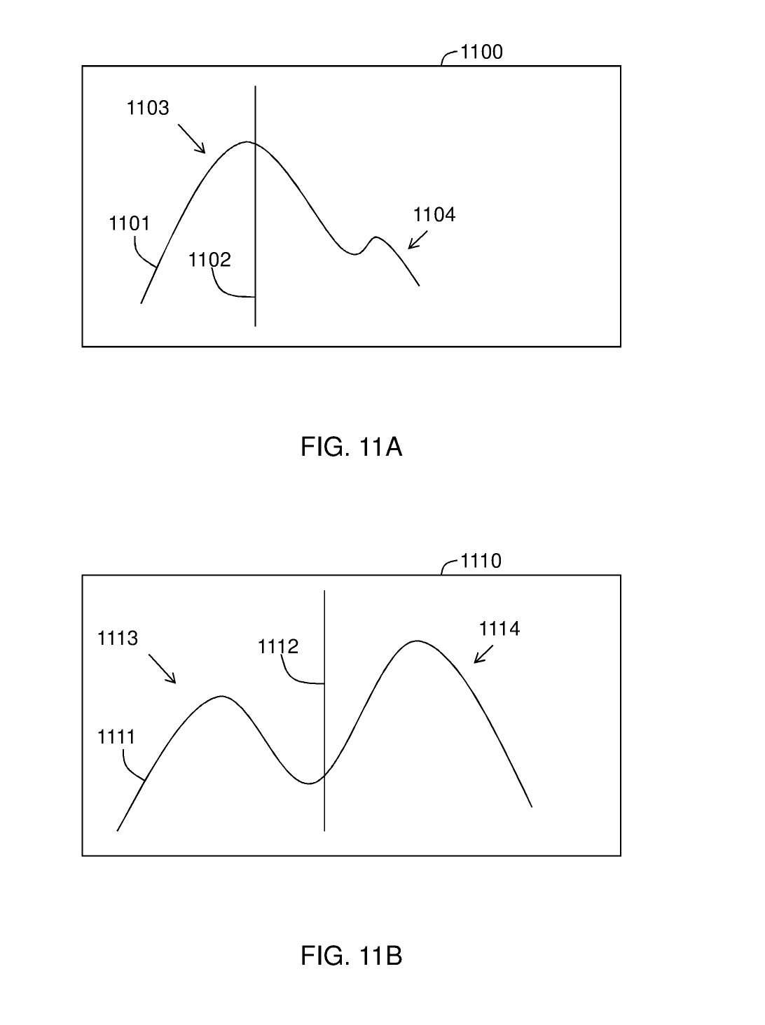

FIGS. 11A and 11B illustrate two other examples of shapes of distribution charts of a services distribution system or network that indicate a less healthy or effective system or network. For example, in FIG. 11A, a line 1101 representing costs per services has a first main bell-type shape 1103 around a median 1102, but also has a second, smaller bell-type shape 1104 to the right of the first bell-type shape 1103, representing outlier service management organizations or service providers that have higher costs than a main body of service management organizations or providers. In embodiments of the invention, a user may interact with a graphic display of the distribution chart 1100 to identify the service management organizations or service providers at any point along the curve 1101. For example, a user may move a cursor onto the curve of the bell-type shape 1104 and service management organization or service provider data may be displayed, permitting the user to identify which service management organizations or service providers are reporting different costs.

Referring to FIG. 11B, another shape of a distribution chart 1110 which may be analyzed to determine a health or effectiveness of a system or network includes a curve 1111 having a first bell-type shape 1113 on one side of a median 1112 and a second bell-type shape 1114 on an opposite side of the median 1112. Based on the different shapes of the distribution charts representing a services management system or network of service management organizations or providers, a user may identify different benefits, successes, drawbacks, or problems in the system or network. A user may be aided in the analysis by a computer or processor capable of analyzing the data making up the distribution charts and generating visual indicators of benefits, successes, drawbacks, or problems in a system or network. In some embodiments, the distribution charts 1008, 1100, and 1110, as well as any distribution chart representing the services management organization network or service provider network is displayed on a visual display for users to interact with. In other embodiments, the distribution charts are generated only as data by a processor, and the results of the data are provided to users, such as information regarding outlier costs and service management organizations or service providers, or information regarding predetermined curve shapes indicating particular successes or failures in the network or system.

While distribution charts and analyzing such charts have been described in detail, embodiments of the invention encompass generating and analyzing any type of chart or graph having shapes that indicate an effectiveness of a system or network, and permitting a user to interact with the chart or graph to obtain information about service management organizations or service providers associated with particular points along the chart or graph.

In block 1202, a user selects a point 1010 on the graph 1008 to obtain information regarding providers and services associated with the point on the graph. In block 1203, provider information regarding the point 1010 is displayed. For example, in FIG. 10, the provider information, cost information is provided in window 1011. Accordingly, a user can quickly see outliers, such as which providers or service management organizations have costs that are too high relative to other providers, and which providers or service management organizations may not be charging as much as other providers or organizations for the same services.

In some embodiments, users can select any point along the graph 1008 to obtain information regarding providers at that point. In some embodiments, a processing and analysis system automatically indicates outliers by providing color coding, bold, or other graphics to distinguish one region of the graph 1008 from another.

Technical effects of embodiments of the invention include reducing a time required to search and analyze large amounts of data by providing a guided analytics platform to allow users to quickly search through data using pre-set, multi-tiered categories, and providing a user interface including a display to allow users to quickly identify outliers in a managed service environment.

Embodiments of the invention encompass any environment in which services are provided to recipients, and data associated with the provided services needs to be searched and analyzed. In an embodiment in which the invention is implemented in a healthcare environment, capitation rate reasonableness may be monitored, trends in health services may be identified, and outliers may be highlighted. Embodiments of the invention capture data from managed care providers regarding services provided. The data is restructured and summarized in summary tables, and queries and scripts are also generated to facilitate the restructuring and searching of the data. In one embodiment, data is searched and analyzed in under ten seconds, although any desired search and analysis time may be utilized. The restructured data may be displayed to a user by allowing the user to select one or more categories to select the summary tables and queries which permit searching of the summary tables. Upon selection of categories, tables display the data from the summary tables. In addition, other graphics and charts are generated to provide quick visual representations of the searched and analyzed data.

While embodiments have been described with respect to “recipients” of services, it is understood that embodiments of the invention also relate to others who do not receive services, such as enrolled persons, members of health service providers, or any other group having data associated with services rendered.

Embodiments of the invention relate to tracking data related to services, and may include data from any administrative or user layer down to the service recipients. For example, in the health services industry, the government may regulate and provide payment to healthcare organizations and insurance companies, which may provide payments to service providers (such as hospitals and doctors), which provide services to patients. Accordingly, embodiments of the invention would track information regarding the government, healthcare organizations, service providers, and patients.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The description of embodiments of the invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments have been chosen and described in order to best explain the principles of the invention and the practical application, and to enable others of ordinary skill in the art to understand the invention for various embodiments with various modifications as are suited to the particular use contemplated.

While some embodiments have been described in this specification, it will be understood that those skilled in the art, both now and in the future, may make various improvements and enhancements which fall within the scope of the claims which follow.

What is claimed is:

1. A services management system, comprising:
a services data retrieval module configured to communicate electronically with one or more data storage devices to obtain services data originating from one or more service management organizations or service providers or service management organizations based on services provided by the service providers to recipients of the services;
a plurality of summary tables, each one of the summary tables containing a quantity of data corresponding to a size in memory less than a size necessary to store the services data in the one or more data storage devices, each of the summary tables having a predetermined size less than a threshold size, said threshold size corresponding to a predetermined threshold time required to search data in a respective summary table among the plurality of summary tables;
a user interface; and
a services data graphical user interface (GUI) generator, including an electronic graphics controller for generating signals to generate an electronic graphics display, configured to generate display data to display on the user interface graphics configured to be selected by a user to display analysis data corresponding to a summary table associated with the graphics selected by the user.

2. The services management system of claim 1, wherein the plurality of summary tables includes a first summary table of a first size based on a first category selectable by the user via the graphics, and a second summary table of a second size equal-to or larger than the first size based on a combination of the first category with a second category selectable by the user via the graphics.

3. The services management system of claim 1, wherein the services data GUI generator is configured to generate graphics representing a first set of categories, each category of the first set being separately selectable by the user and corresponding to a summary table of a predetermined size less than a threshold size corresponding to a threshold search time to search the summary table,
wherein the summary table of the predetermined size contains data from one or more categories based on an amount of data associated with the one or more categories.

4. The services management system of claim 3, wherein the services GUI generator is configured to generate graphics representing a second set of categories based on a selection by the user of one of the categories of the first set of categories, the second set of categories including at least one category not in the first set of categories.

5. The services management system of claim 4, further comprising a summary table data analysis module configured to search a single summary table having contents limited to a combination of each of a selected category of the first set of categories and a selected category of the second set of categories based on a user selection of the selected category of the second set of categories.

6. The services management system of claim 1, wherein the services data GUI generator is configured to generate display of a planned or expected cost associated with a service, the planned or expected cost set by an oversight entity, and an actual cost associated with the service, the actual cost calculated based on services data in a summary table selected by the user.

7. The services management system of claim 1, further comprising a summary table data analysis module, including a processor for electronically retrieving data from the plurality of summary tables, configured to provide to the GUI generator services data including an actual cost associated with the service based on the service being provided to recipients, said services data obtained from a first summary table corresponding to a first category displayed on a GUI generated by the GUI generator and selected by the user.

8. The services management system of claim 1, wherein the GUI generator is configured to generate a distribution chart based on an actual cost associated with a service and one or more service management organizations or service providers, the distribution chart displaying normal costs defined relative to a median value and outlier costs defined relative to the median value,
wherein the GUI generator is configured to display service provider identification information or service management identification information associated with a point on the distribution chart based on the user interface receiving an input from the user selecting the point on the graph.

9. The services management system of claim 8, further comprising a summary table data analysis module configured to provide to the GUI generator services data including the actual cost associated with the service based on the service being provided to recipients, said services data obtained from a first summary table corresponding to a first category displayed on a GUI generated by the GUI generator and selected by the user.

10. The services management system of claim 1, wherein the GUI generator is configured to display services data associated with a plurality of service providers based on the user selecting at least one category defining the scope of the services data, and
the GUI generator is configured to display an outlier indicator to identify one or more of a service, a service provider, and a service management organization having service cost characteristics outside a predetermined range of the median value.

11. A services management system, comprising:
a services data retrieval module configured to communicate electronically with one or more data storage devices to obtain services data originating from one or more service management organizations or service providers based on services provided by the service providers to recipients of the services;
a services summary table populator configured to divide the services data into a plurality of separate summary tables corresponding to categories defining bounds of the summary tables, the services summary table populator configured to generate the separate summary tables to each have a size less than a pre-determined size corresponding to a predetermined search time for searching each summary table; and
a services data graphical user interface (GUI) generator configured to generate display data to display on a user interface graphics configured to be selected by a user to display analysis data corresponding to a summary table associated with the graphics selected by the user.

12. The services management system of claim 11, wherein the predetermined search time for searching each summary table is at least an order of magnitude less than a search time required to search the services data in the one or more storage devices.

13. The services management system of claim 11, wherein the services summary table populator is configured to generate a first summary table of a first size based on a first category selected by the user by interacting with the graphics, and a second summary table of a second size equal-to or larger than the first size based on a combination of the first category with a second category selected by the user by interacting with the graphics.

14. A method of managing services, comprising:
retrieving, from one or more storage devices, services data originating from one or more service management organizations or service providers or service management organizations based on services provided by the service providers to recipients of the services, said retrieving performed by electronically transmission of the services data from the one or more storage devices;
updating a plurality of summary tables based on the services data, each one of the summary tables containing a quantity of the services data corresponding to a size in memory less than a size necessary to store the services data in the one or more data storage devices, each of the summary tables having a predetermined size less than a threshold size, said threshold size corresponding to a predetermined threshold time required to search data in a respective summary table among the plurality of summary tables;
generating a graphical user interface (GUI) including graphics selectable by a user to display analysis data corresponding to a summary table associated with the graphics selected by the user;
receiving a user input from the user selecting the graphics; and
displaying the analysis data corresponding to the summary table associated with the graphics selected by the user.

15. The method of claim 14, wherein the plurality of summary tables includes a first summary table of a first size corresponding to a first category represented by the graphics selected by the user, and a second summary table of a second size equal-to or larger-than the first size based on a combination of the first category with a second category selected by the user.

16. The method of claim 14, wherein generating the GUI includes generating graphics representing a first set of categories, each category of the first set being separately selectable by the user and corresponding to a summary table of a predetermined size less than a threshold size corresponding to a threshold search time to search the summary table.

17. The method of claim 16, wherein generating the GUI includes generating graphics representing a second set of categories based on a selection by the user of one of the categories of the first set of categories, the second set of categories including at least one category not in the first set of categories.

18. The method of claim 17, further comprising electronically searching a single summary table having contents limited to a combination of each of a selected category of the first set of categories and a selected category of the second set of categories based on a user selection of the selected category of the second set of categories.

19. The method of claim 14, wherein generating the GUI includes generating a display of a fixed (or planned or estimated) cost associated with a service, the fixed (or planned or estimated) cost set by an oversight entity, and an actual cost associated with the service, the actual cost calculated based on services data in a summary table selected by the user.

20. The method of claim 14, wherein generating the GUI includes generating a distribution chart based on an actual cost associated with a service and one or more service management organizations or service providers or service management organizations, the distribution chart displaying normal costs defined as costs within a median of costs and outlier costs defined as costs outside a range of costs, and displaying service provider identification information associated with a point on the distribution chart based on the user interface receiving an input from the user selecting the point on the distribution curve chart.

21. The method of claim 20, further comprising:
identifying an effectiveness of a network of a plurality of the service management organizations or service providers based on a shape of the distribution chart.

22. The method of claim 14, wherein generating the GUI includes displaying services data associated with a plurality of service providers based on the user selecting at least one category defining the scope of the services data, and displaying an outlier indicator to identify one or more of a service, a service provider, and a service management organization having service cost characteristics outside a predetermined range.

23. A services management method, comprising:
retrieving, from one or more storage devices, services data originating from one or more service management organizations or service providers or service management organizations based on services provided by the service providers to recipients of the services, said retrieving performed by electronically transmission of the services data from the one or more storage devices;
generating a plurality of summary tables by dividing the services data based on categories defining bounds of the summary tables, each of the summary tables having a size less than a pre-determined size corresponding to a predetermined search time for searching each summary table;
displaying graphics on an electronic display device, said graphics including icons representing one or more of the categories; and
displaying, on the electronic display device, analysis data corresponding to a summary table associated with a category selected by the user by interacting with the graphics on the display device.

24. The services management method of claim 23, wherein the predetermined search time for searching each summary table is at least an order of magnitude less than a search time required to search the services data in the one or more storage devices.

25. The services management method of claim 23, wherein generating the plurality of summary tables includes generating a first summary table of a first size based on a first category selected by the user by interacting with the graphics, and a second summary table of a second size equal-to or larger-than the first size based on a combination of the first category with a second category selected by the user by interacting with the graphics.
